(19) United States
(12) Patent Application Publication
(10) Pub. No.: US 2016/0283501 A1
(43) Pub. Date: Sep. 29, 2016

(54) POSIX-COMPATIBLE FILE SYSTEM, METHOD OF CREATING A FILE LIST AND STORAGE DEVICE

(71) Applicant: FUJITUS TECHNOLOGY SOLUTIONS INTELLECTUAL PROPERTY GMBH, München (DE)

(72) Inventors: Christoph König, Ottobrunn (DE); Alexander König, Ottobrunn (DE)

(21) Appl. No.: 14/761,413

(22) PCT Filed: Oct. 13, 2014
(86) PCT No.: PCT/EP2014/071892

§ 371 Date: Jul. 16, 2015

(30) Foreign Application Priority Data
Dec. 17, 2013 (DE) 10 2013 114 214.1

(51) Int. Cl. G06F 17/30

(52) U.S. Cl. CPC G06F 17/30106; G06F 17/30091; G06F 17/3007

(57) ABSTRACT

A storage device includes at least one interface to access files stored by the storage device, and at least one mass storage system for non-volatile storage of files; wherein the storage device is configured, on receiving a write command to write a file via the at least one interface, to store metadata relating to the at least one file in an inode associated with the file of the mass storage system, and the stored metadata relating to the file include at least the file name of the file and information relating to a directory in which the file is stored.

### TECHNICAL FIELD

This disclosure relates to a POSIX-compatible file system comprising at least one directory and a plurality of files stored in the directory. In addition, the disclosure relates to a method of creating a file list of files of a POSIX-compatible file system, use of extended attributes and a storage device.

### BACKGROUND

POSIX-compatible file systems are known. In particular, most known Linux distributors are based on different, POSIX-compatible file systems such as, for example, ext2 and ext3. File systems of this type generally have a relatively high flexibility and are suitable for storing a large number of files.

POSIX-compatible file systems manage physical data media using so-called “inodes”, wherein the inodes contain metadata relating to information stored on the data medium. Examples of such metadata are access rights and a creation, modification and read date of files stored in the file system. Information of this type is used, inter alia, by backup and archiving solutions to manage the files stored in the file system.

However, evaluation and updating of such and similar metadata can also cause problems, particularly in very large file systems of the type which occur, for example, in so-called “Big Data” applications.

There is thus a need to provide a POSIX-compatible file system and methods and devices for its creation and use which have an improved performance compared to known implementations. In particular, it could be helpful to reduce the number of I/O accesses to a mass storage system when searching through files stored on the mass storage system.

### SUMMARY

We provide a storage device including at least one interface to access files stored by the storage device, and at least one mass storage system for non-volatile storage of files; wherein the storage device is configured, on receiving a write command to write a file via the at least one interface, to store metadata relating to the at least one file in an inode associated with the file of the mass storage system, and the stored metadata relating to the file include at least the file name of the file and information relating to a directory in which the file is stored.

We further provide a method of creating a file list of files of a POSIX-compatible file system including scanning a predefined group of inodes to acquire metadata of a plurality of files allocated to the inodes, wherein the metadata for each file stored in one of the inodes include at least the file name of respectively allocated file and information relating to a directory in which the respective file is stored; defining file names and path specifications of files based on the metadata stored in the inodes; and creating a file list on the basis of the defined file names and path specifications.

We yet further provide a mass storage system including a POSIX-compatible file system including at least one directory and a plurality of files stored in the directory, wherein an inode with metadata relating to the respective file is allocated to each file; the directory includes an allocation between file names of the plurality of files and the inode respectively allocated to a file; and the metadata relating to the respective file include at least the file name of the allocated file and information relating to the at least one directory.

### BRIEF DESCRIPTION OF THE DRAWINGS

FIGS. 1A to 1C show a tree representation, a memory map and a list representation of a POSIX-compatible file system in general.

FIGS. 2A and 2B show a conventional data structure and a conventional method of creating a file list.

FIGS. 3A and 3B show a data structure and a method according to a first example.

FIGS. 4A and 4B show a data structure and a method according to a second example.

FIG. 5 shows a schematic representation of the storage device according to one example.

### REFERENCE NUMBER LIST

1 Directory system
2 File system
3 Root directory
4 Physical data medium
5 First storage area
6 Second storage area
7 Inode
8 Directory object
9 File object
10 File list
11 List entry
12 (Full) path specification
13 (Simple) path specification
14 Filename
15 Address (of the inode)
16 Further attribute
17 Directory entry
18 Back reference
19 Reference (to reference point)
20 Backup date
50 Storage device
51 Mass storage system
52 Tape drive
53 Cloud memory
54 First interface
55 Processing component
56 Second interface
57 Configuration dialog
58 Scan device
59 Object mover
60 Backup manager

### DETAILED DESCRIPTION

We provide a POSIX-compatible file system comprising at least one directory and a plurality of files stored in the directory. An inode with metadata relating to the respective file is allocated to each file, and the directory comprises an allocation between file names of the plurality of files and the inode respectively allocated to a file. The metadata relating to the respective file comprise at least the file name of the allocated file and/or information relating to the at least one directory.

A file system of this type allows the definition of file names and/or path specifications purely on the basis of metadata stored in the inodes. For example, a file system of this type allows a file list to be created on the basis of a combination of name and directory information of the metadata of the inodes without the need to access other data blocks of the file system, in particular, directories. The storage of either only the directory or name information allows at least a prefiltering of associated file objects so that fewer other data blocks need to be accessed. I/O accesses to other parts of a mass storage system can be avoided or reduced through localization of name and/or directory information in the inodes. Management tasks based on corresponding information and metadata can thus be speeded up.

The information relating to the at least one directory may comprise a reference to an inode allocated to the directory. Through the provision of a reference to an inode of a high-order directory, the path to the file can be constructed in reverse, starting from an inode of a file without the need to construct a directory structure by reading directory objects.

Alternatively, the file system may be designed as a WORM file system and the information relating to the at least one directory comprises a path specification of the allocated file from a predefined reference point, in particular, a mountpoint of the WORM file system. If the file system is designed as a so-called WORM (“write once, read multiple”) file system, i.e. as a file system that is writable once only, following the first storage of a file, no further changes can be made to its path, for example, by renaming or moving the file or from high-order directories. In this case, the full path specification can be stored in the inode allocated to the file. In a system of this type, it is possible to construct a file list of file specifications to files and associated inodes by a linear scan through the list of inodes.

Extended attributes of the file system may be used to store the file name and the information relating to the at least one directory.

We also provide a method of creating a file list of files of a POSIX-compatible file system. The method comprises the following steps:

scanning a predefined group of inodes to acquire metadata of a plurality of files allocated to the inodes, wherein the metadata comprise at least the file name of the respectively allocated file and/or information relating to a directory in which the respective file is stored;

defining file names and/or path specifications of files based purely on the metadata stored in the inodes; and

creating a file list on the basis of the defined file names and path specifications.

The aforementioned method allows creation of a file list based exclusively on information contained in inodes of a POSIX-compatible file system. In this way, in particular, the multiple forward and backward jumping of write/read heads of a physical storage device between a first memory area with information of the inodes and a second storage area with other data blocks can be avoided so that construction of the file list is speeded up on the whole.

The metadata may comprise at least one further attribute, in particular a date of a last backup of the respectively allocated file, wherein the at least one further attribute is transferred into the file list and/or a transfer of a file into the file list is decided on the basis of the at least one further attribute. Through the combination of the file name with further attributes of the associated file, in particular a date of a last backup, backup and archiving systems and similar software programs can decide which files need to be further processed, for example, backed up purely on the basis of the metadata contained in the inodes.

We further provide a storage device comprising at least one interface to access files stored by the storage device and at least one mass storage system for non-volatile storage of files. The storage device is configured, on receiving a write command to write or modify a file via the at least one interface, to store metadata relating to the at least one file in the mass storage system, or to modify metadata already stored, wherein the stored metadata relating to the file comprise at least the file name of the file and/or information relating to a directory in which the file is stored.

The aforementioned storage device stores the necessary information to carry out the aforementioned method and provides a POSIX-compatible file system.

The storage device may furthermore comprise a software component, wherein the at least one software component is configured to create a file list purely on the basis of the stored metadata. For example, this may entail a software component for file management which selects files for further processing purely on the basis of the stored metadata. In particular, a backup of files can be carried out on the basis of at least one time specification stored in the metadata, in particular a comparison of an additionally stored date of the last backup with a stored default date of a last modification of the file allocated to the metadata.

Further advantages and details are disclosed in the detailed description of examples.

Our methods, systems, and devices are described in detail below on the basis of different examples with reference to the attached figures. Different instances of identical or identically functioning components are denoted with alphabetical suffixes. If all instances are intended to be referred to jointly, the corresponding suffix is omitted.

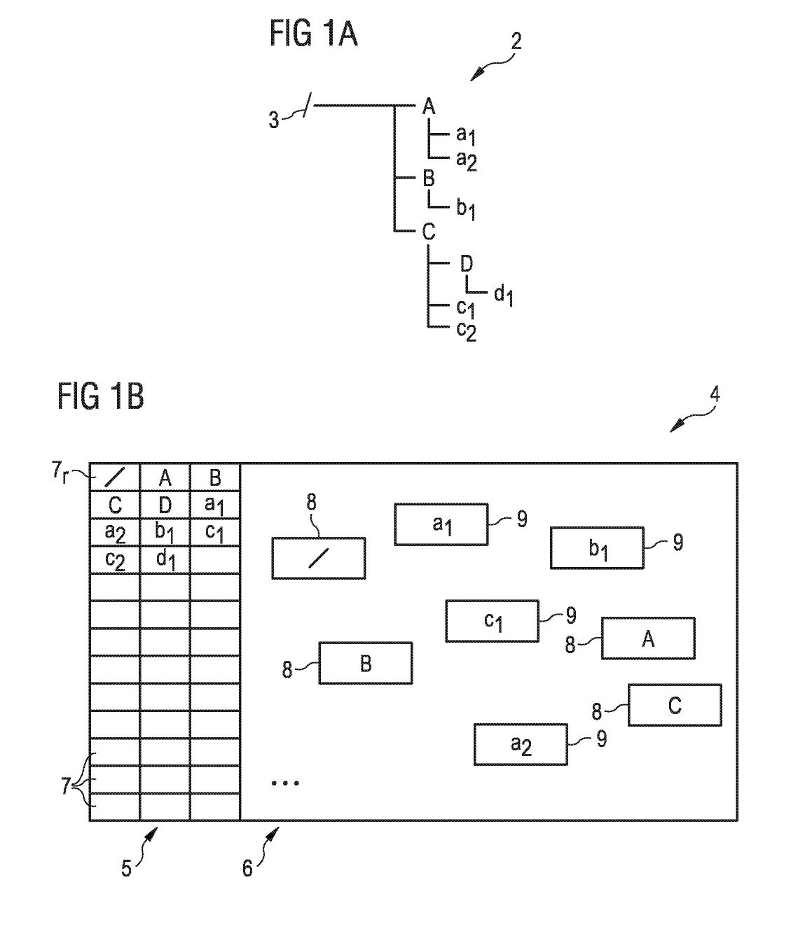

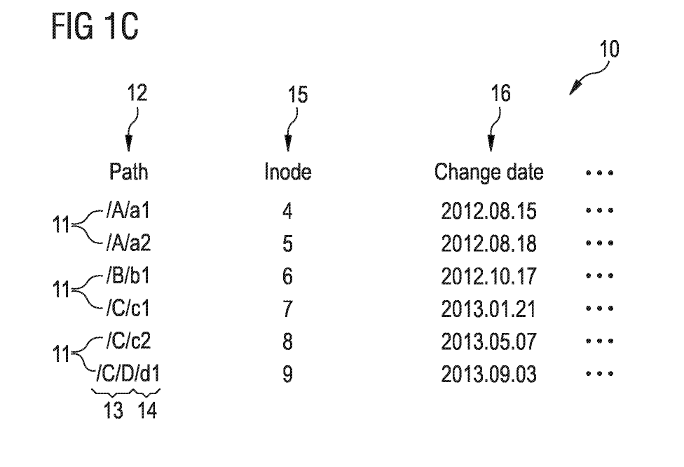

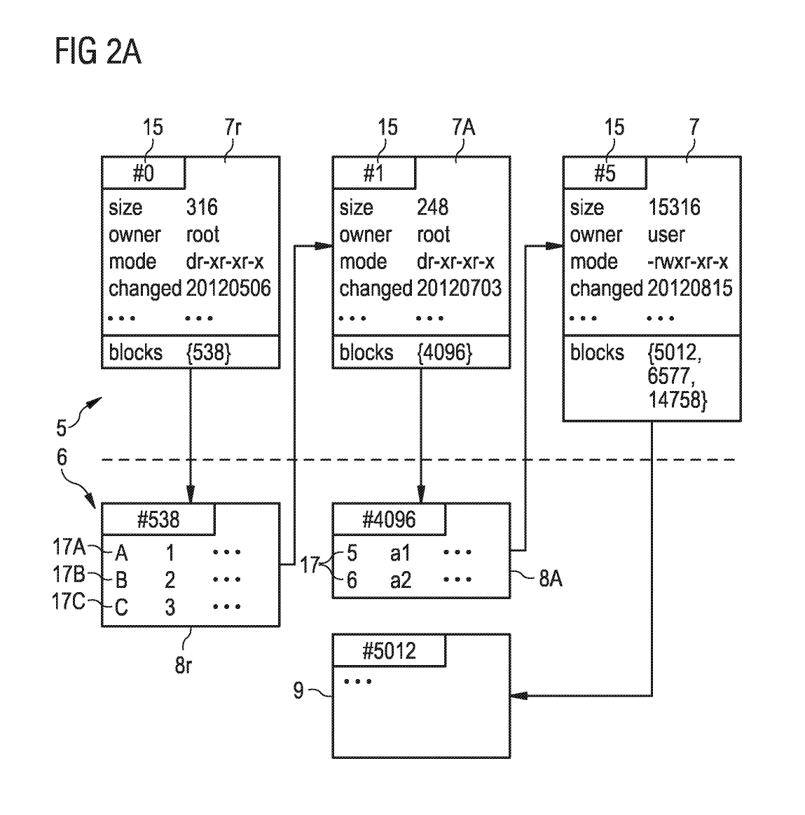

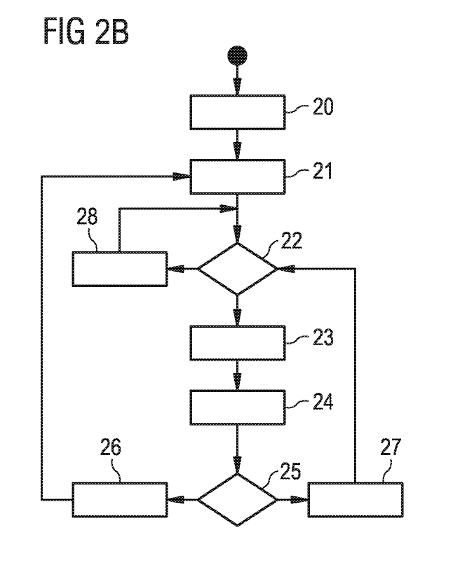

For better understanding, a POSIX-compatible file system is first described in general below with reference to FIGS. 1A to 1C, along with a conventional data structure for its implementation and a method of creating a file list with reference to FIGS. 2A and 2B.

FIG. 1A shows a directory tree 1 of a POSIX-compatible file system 2. For clearer distinction, uppercase letters are used below to denote directories and lowercase letters and digits to denote regular files of the file system 2. Obviously, POSIX-compatible file systems 2 normally allow the use of uppercase and lowercase letters and digits and other special characters for both directory names and file names. Furthermore, significantly longer names and creation of significantly more complex directory trees than those shown in FIG. 1A are possible.

Insofar as files are referred to in the following description and attached claims, this should be understood to mean regular files in the sense of a POSIX-compatible file system, i.e. the user data stored in the file system 2. Other objects such as, in particular, directory objects, so-called hard and soft links and other metadata of the file system 2 are explicitly marked as such below to distinguish them more clearly from regular files.

The directory tree 1 comprises a so-called root directory 2 normally denoted by the forward slash “/” in the UNIX operating system and related operating systems such as, for example, Linux. The directory tree 1 initially branches from the root directory 3 into three directories A, B and C of a first hierarchy level. In the directory tree 1 according to FIG. 1, the first directory A contains two regular files a1 and a2. The second directory B comprises one single file b1. The third directory C comprises a further subdirectory D of a second hierarchy level and also regular files c1 and c2. In the example according to FIG. 1, a further file d1 is stored in the second-order subdirectory D.

It should be noted here that the directory tree 1 shown in FIG. 1A represents a simplified special case which contains only one single master file system without so-called mountpoints or any kind of links between different file objects and directory objects of the file system 2. It is generally customary in POSIX-compatible file systems to incorporate the content of further mass storage systems with directory trees stored therein at predefined locations, the mountpoints, of a higher-order file system, normally the master file system with the root directory 3. Similarly, network-like structures can be created through the use of soft or hard links so that a plurality of paths can lead from the root directory 3 to one and the same regular file. Structures of this type are not shown here for the sake of clarity. Their significance for implementation of the devices and methods described below is described at the corresponding place.

FIG. 1B schematically shows a data structure to map the directory tree 1 onto a physical data medium 4. For example, the physical medium 4 is a mass storage system in the form of a hard disk drive or flash drive. However, other storage media are in principle possible.

In the example, the physical data medium 4 is divided into a first storage area 5 and a second storage area 6. This may entail, for example, a division according to block addresses or other address specifications of the physical data medium 4. A division of this type is normally undertaken during a first initialization of the data medium 4, for example, during its formatting with the file system 2.

In the example, so-called inodes are stored in the first storage area 5. The inodes are POSIX-compatible data blocks with metadata relating to the data stored in the file system 2. The precise data structure of the individual inodes 7 is described below with reference to FIG. 2A. In the representation according to FIG. 1B, a predefined inode 7r is allocated to the root directory 3. This entails, for example, a first addressable block of the first storage area 5. Further inodes 7 are allocated to the directories A, B, C and D and to the files a1, a2, b1, c1, c2 and d1. The respective allocation between the inodes 7 and the associated directories or files is dependent on the implementation of the file system 2. The inodes 7 of the first storage area 5 are shown in the aforementioned sequence purely for the sake of clarity. In practice, however, the allocation of inodes to associated directories or files depends more on the sequence of their creation.

The actual data of the file system 2 are stored in the second storage area 6. In particular, a directory object 8 is stored in the second storage area 6 for each of the directories A, B, C and D and the root directory “/”. The corresponding directory objects 8 essentially comprise a list of list entries, wherein each list entry indicates the names and associated inodes of the objects stored in the directory. For example, the directory object 8 comprises two list entries for the directory A with the file names a1 and a2 and an associated numerical address of the inodes 7 allocated to the files a1 and a2. File objects 9 of regular files allocated to corresponding inodes 7 of the first storage area 5 are furthermore stored in the second storage area 6. Depending on the size of the stored files, the actual data may extend over one or more file objects 9. However, this is not shown in FIG. 1B for the sake of clarity.

In very large files, a single inode 7 is not always sufficient for storing references to all file objects 9 of the second storage area 6 in one single inode 7. In this case, the inode 7 refers to further, second-order or third-order inodes 7 so that a large number of references to corresponding file objects 9 can be stored. In terms of further details, reference is made, for example, to the “Inodes” article in the English-language online encyclopedia Wikipedia dated 27 Oct. 2013.

A file list 10 is shown in FIG. 1C. The file list 10 comprises list entries 11 for regular files. Each list entry 11 comprises at least one full path specification 12, consisting of a simple path specification 13 to the directory in which the file is stored, along with the actual file name 14, a numerical address 15 of the inode 7 allocated to the file and further attributes 16 of the file such as, for example, the date of a creation or last amendment of the file. The information in the file list 10 may, for example, be used by software components of an archiving system to decide which file objects 9 of the second storage area 6 need to be stored on a further storage medium such as, for example, a magnetic backup tape.

However, file lists 10 of this type are required, inter alia, in hierarchical storage systems (HSM) for other systems and programs to manage large volumes of data. A problem with known POSIX-compatible file systems is that the creation of a file list 10 of this type requires, inter alia, a considerable amount of time. Particularly in so-called “Big Data” systems with millions of files distributed over different nodes of a cluster system, the creation or maintenance of a corresponding file list 10 is impossible in the time available for this purpose with known file systems.

It is described below with reference to FIGS. 2A and 2B how a file list 10 according to FIG. 1C can be created in conventional file systems on the basis of the information stored on the physical data medium 4. FIG. 2A shows schematically the data structures used for this purpose and FIG. 2B shows a flow diagram of a conventional method of processing a directory tree 1 to create the file list 10.

In a first step 20, the inode 7r of the root directory 3 is defined and loaded. For example, an inode entry with the address “0” can be read in from the first storage area 5. The actual path, represented in this case by a single “/”, is simultaneously retained in a working variable p.

In a step 21, an associated directory object 8r is then loaded from the second storage area 6. In the example shown in FIG. 2A, the directory object 8r comprises three directory entries 17 for the directories A, B and C of the first hierarchy level.

In a following step 22, it is established accordingly that further directory entries 17 to be processed are present in the directory object 8r.

In the next step 23, the first directory entry 17A relating to the still unknown storage object A is first read in. The directory entry 17A indicates that the inode 7A with the address “1” is allocated to the storage object A. The name “A” of the storage object is furthermore indicated by the directory entry 17A.

In the next step 24, the associated inode 7A of the storage object A with the address “1” is loaded to define the metadata associated with the storage object A.

In step 25, a check is carried out to determine what type of object the storage object A is. From the loaded metadata of the inode 7A, it is possible to determine, for example, on the basis of the so-called mode information, whether, as in this case, a further directory or a regular file or another object of a POSIX-compatible file system 2 is involved. In FIG. 2B, only the processing of files and directories is indicated in the interests of simpler presentation.

If, as in this case, a further directory 8 is involved, the working variable for the path p to be investigated is supplemented in a next step 26 with the name defined in step 23. Furthermore, the hitherto valid directory is temporarily stored in a further variable q. The method is then continued recursively in step 21 with the loading of the associated directory object 8A.

In the example described, the directory A contains only regular file objects 9 for the files a1 and a2. In the subsequent check in step 25, it is established accordingly that the directory entries 17 of the directory objects 8A refer to regular files. In a step 27, a list entry 11 is generated accordingly for the file list 10 based on the current path p and the file name “a1” taken from the directory entry 17 in step 23. The method is then continued in step 22 for the next directory entry 17. A further list entry 11 is generated accordingly for the file a2 in a subsequent loop in step 27.

In a repetition of step 22, it is established that no further directory entries 17 in the directory A are to be processed. In a following step 28, the path is reset accordingly to the higher-order directory of the directory A, i.e. the root directory “/”, and the method is continued at the next higher level in step 22.

By the method described, the root tree 1 shown in FIG. 1A is visited progressively by the recursive algorithm, wherein directory entries 17 for file objects 9 are created in the file list 10.

As shown in particular in the representation according to FIG. 2A, the method according to FIG. 2B causes a regular jumping back and forth between the first storage area 5 and the second storage area 6. The reason for this is, in particular, that the associated directory object 8 and file objects 9 cannot be located in the second storage area 6 without reading the information of the inodes 7 from the first storage area 5. Conversely, all information is not available in the inodes 7 of the first storage area 5 for example, to define names and path specifications of individual files or to determine the hierarchical structure of the directory tree 1. In practice, this procedure therefore has the disadvantage that a frequent repositioning of write/read heads or other read devices of the physical data medium 4 is required to create the file list 10. Particularly in very large file collections such as those which occur in archiving systems, this results in practice in long transit delays and therefore problems in frequently running processes.

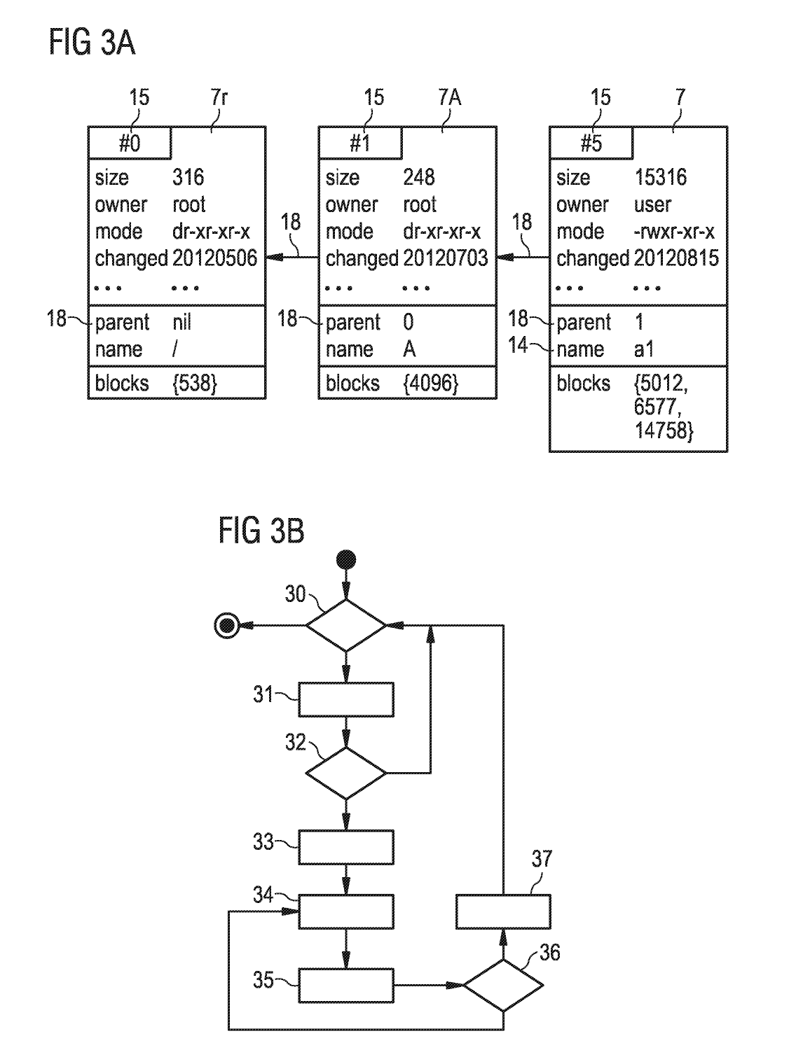

FIG. 3A shows an improved data structure for mapping the directory tree 1 described above. In particular, the name of the associated file object 9 or directory object 8 is stored in the individual inodes 7 in addition to the aforementioned information. A back reference 18 to the inode 7 of a high-order directory object 8 is similarly stored in the inodes 7, i.e. in the inode 7A of the directory A, for example, a reference to the inodes 7r. No entry is present only in the inode 7r of the root directory 3 itself.

A further reference to a predefined reference point of the file system 2 can optionally be stored in all inodes 7 (not shown in FIG. 3A). In the simple directory tree 1 according to FIG. 1A, entry for the reference point refers directly to the root directory 3. In more complex directory trees distributed over a plurality of data media and accordingly have a plurality of mountpoints, the reference point refers to the mountpoint of the file system containing the file. In this way, the metadata stored in the inodes 7 remain valid even if the file system concerned is incorporated elsewhere in a high-order file system, in particular the master file system.

The name of the associated file object 9 or directory object 8, the back reference 18 and, where relevant, the reference to the reference point may, for example, be stored as extended attributes of known file systems, for example, through the use of the so-called “xattr function”.

FIG. 3B shows an improved method of creating the file list 10 on the basis of the data structure according to FIG. 3A.

In a first step 30, a check is carried out to determine whether further inodes 7 of a list of inodes are to be processed. For example, the inode list may comprise all inodes 7 of the first storage area 5.

If so, the next inode 7 to be processed is read in step 31. In a next step 32, a check is carried out to determine whether the inode 7 is allocated to a regular file object 9. If not, the processing can be continued immediately with the next inode 7 in step 30.

Conversely, if it is established in step 32 that the last-read inode 7 is allocated to a regular file object 9, for example, the file a1, the address 15 of the inode 7 and the associated name “a1” of the file object 9 are temporarily stored in a variable n.

In a step 34, the inode 7A which the back reference 18 of the previously loaded inode 7 references as inode 7A of the high-order directory object 8A is then loaded. In a step 35, the variable n is then supplemented with the name “A” of the higher-order directory A.

In a step 36, a check is carried out to determine whether the higher-order directory is already the root directory 3. If so, the full path specification 12 now contained in the variable n comprising the path specification 13, the file name 14 in the file list 10 and the address 15 of the inode 7 allocated to the regular file “a1” is stored in a step 37. The method is then continued in step 30 with the processing of any further inodes 7 from the inode list.

However, if it is established in step 36 that the root directory 3 is not yet involved, the method is continued in step 34 with the loading of the inode 7 of the directory is of a higher order than the current directory so that the path is supplemented in step 35 with the next higher directory level until the method finally arrives at the root directory 3. In this way, a full path specification 12 can be determined in a very short time for each inode 7 by following the back references 15 to higher-order inodes 7. Conversely, in conventional file systems 2, the construction or search via a complete directory tree would be necessary.

The method according to FIG. 3B has a range of advantages over the method according to FIG. 2B. In particular, a jumping back and forth between the first storage area 5 and the second storage 6 on the physical data medium 4 can be avoided during creation of the file list 10. All data required to create the file list 10 are stored in their entirety in the inodes 7.

At the same time, a complete recursive processing of the directory tree 1 can be dispensed with. In particular, it is possible to carry out a linear scan over all inodes 7 stored in the first storage area 5. A full path specification 12 must be added by a recursive algorithm only for the inodes 7 allocated to a regular file object 9 and whose other metadata correspond, for example, to a specific search profile.

In particular, if a multiplicity of inodes 7 can already be excluded from this processing on the basis of a prefiltering, for example, in an archive system which records only the filenames of files modified since a last backup time, this recursive component of the algorithm, however, plays only a subordinate role in the latter's transit delay behavior.

In a variation of the example according to FIG. 3A which is not graphically shown, the inodes 7 contain only the back reference to the higher-order directory 8, but no attribute with the name of the file object 9 or directory object 8 associated with the inode 7. In this design, the directory object 8 of the second storage area 6 must still be accessed to create a file list 10. However, the number of I/O accesses can already be significantly reduced in this design if only paths for a relatively small proportion of the inodes 7 have to be defined. For example, as explained later, only specific files can be selected for a specific processing such as a backup, on the basis of the other metadata contained in the inode 7. If, for example, only 1% of the stored file objects 9 are backed up, construction of path specifications for the selected inodes 7 still entails significantly fewer I/O accesses than a complete search through the root tree 1 due to the reading in of a small number of directory objects 8.

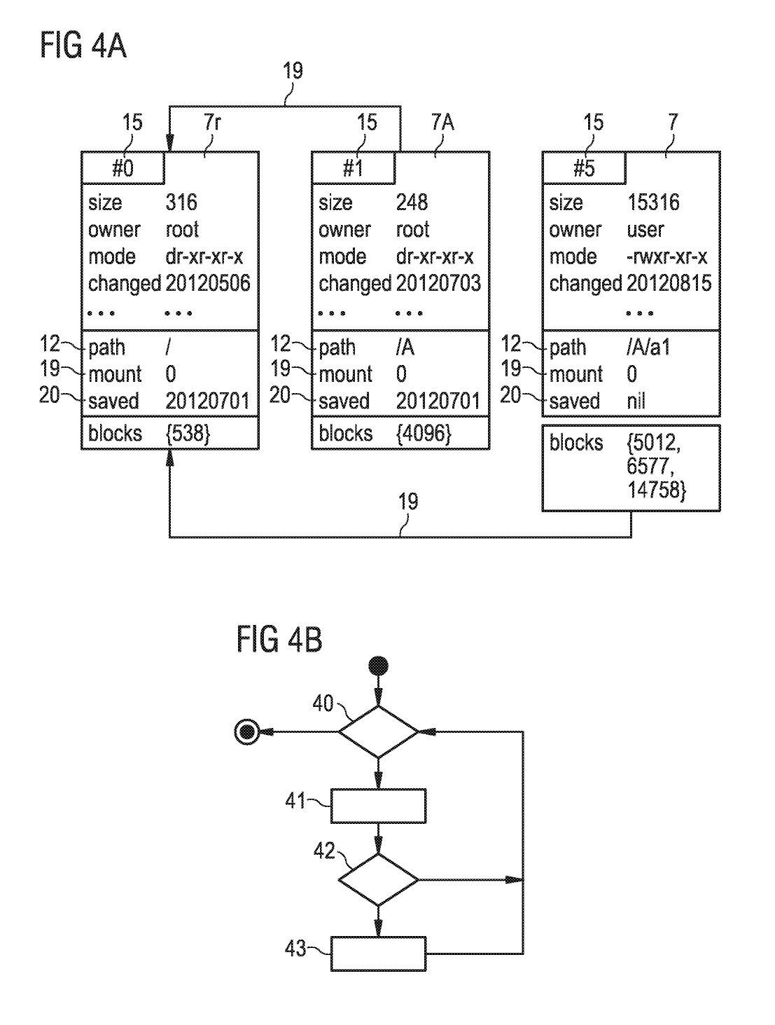

FIGS. 4A and 4B show a data structure and a working method according to a further example. As shown particularly in FIG. 4A, a path specification 12, at least from the higher-order mountpoint, is stored in the inodes 7 according to the further example instead of the name of the storage object and the back reference 18 to the inode 7 of a higher-order directory object 8. Furthermore, a reference 19 to the inode 7 of a higher-order reference point is stored in each inode 7. In the design described, the root directory 3 serves as a reference point for objects of the master file system, here a reference to the inode 7r. The inode of the mountpoint of the corresponding incorporated file system at which the path specification 12 begins is stored as a reference point for objects of other file systems incorporated into the master file system, for example, other partitions of a hard disk, network volumes or exchangeable storage media. Finally, a backup date 20 indicating the time of a last backup of the associated object on a further storage medium, for example, a tape storage medium, by a backup component, is additionally stored in each inode 7.

In a variation of the design according to FIGS. 4A and 4B, a fixed reference point, for example, the root directory 3 or a different defined node of the file system 2, is permanently predefined or stored elsewhere. In this design, the storage of the reference 19 in the inodes 7 can be dispensed with. Only one single additional attribute, i.e. a full path specification 12 comprising the simple path specification 13 from the root directory 3 and the file name 14 itself, is preferably stored as a continuous character string in this design.

The data structure according to FIG. 4A and its variation described above are suitable for even faster creation of file lists 10. In the example, the file system 2 is a so-called WORM file system in which, following the initial writing of a file or the creation of a directory, name changes and moves are then no longer possible. Since the path to a file, once stored, from the given reference point, either a mountpoint or the root directory 3, can thus effectively no longer be changed, the full path specification 12, as shown in FIG. 4A, can be stored in continuous form in an extended attribute of the inode 7.

In this case, creation of a file list is particularly simple. In a first step 40, a check is carried out to determine whether further inodes 7 of a list of inodes are to be processed. If so, the first inode 7 to be processed is loaded in step 41. A check is then carried out in step 42 to determine whether the loaded inode 7 is allocated to a regular file object 9. If not, the method can be continued in step 40 with the processing of any further inodes 7. Otherwise, an entry for the file list 10 can be created immediately in step 43. If the stored reference point directly involves the root directory 3, the information stored in the current inode 7 for the full path specification 12 of the file object 9 can be used directly to create the entry. In more complex file systems with a plurality of mountpoints, a path from the root directory 3 to the respective stored mountpoint must also be defined. This is also normally possible without further I/O accesses to a mass storage system since only a small number of mountpoints, which are stored at a central location, in particular a so-called fstab (file system table), are normally present, even in complex file systems. The content of the file system table fstab is required for a multiplicity of different purposes and is therefore normally stored in a cache memory or other memory-resident data structure. The entry can thus be formed by combining a temporarily stored path to the indicated mountpoint and the data for the path specification stored in the inode 7. The method is then continued in step 40 with the next present inode 7, if applicable.

The method according to FIG. 4B also has the advantage that the information stored in the inodes 7 is alone sufficient to create the file list 10. In addition, the method according to FIG. 4B has the advantage that recursive creation of file specifications is then no longer required at all. Instead, the file list 10 can be created by a simple, linear algorithm which, as a rule, sequentially processes consecutively stored inodes 7. By this method, an acceleration by a factor of approximately 100 compared with known directory search runs is possible in file systems with several million inodes 7.

Insofar as a decision relating to a possible further processing of the file objects 9 can be made purely on the basis of the metadata stored in the inodes 7, the data of the second storage area 6 no longer need to be read in at all, which results in a further substantial acceleration of the method.

In the example shown, the additional backup date 20, inter alia, is used for this purpose. In the example described, all objects of the file system are intended to be backed up regularly on a further storage medium, for example, a magnetic tape. A so-called “incremental backup” method is used here in which only objects newly added or modified since a previous backup are intended to be backed up. The decision as to which objects need to be backed up in a forthcoming backup run can be made purely on the basis of the information stored in the inodes 7. FIG. 4A shows, in particular, that the root directory 3 has not been further modified since the last backup on 1 Jul. 2012 and does not therefore need to be backed up. However, the directory A was last modified on 3 Jul. 2012 and therefore after its last backup on 1 Jul. 2012 and must accordingly be backed up. The regular file a1 has not yet been backed up at all and must therefore similarly be backed up.

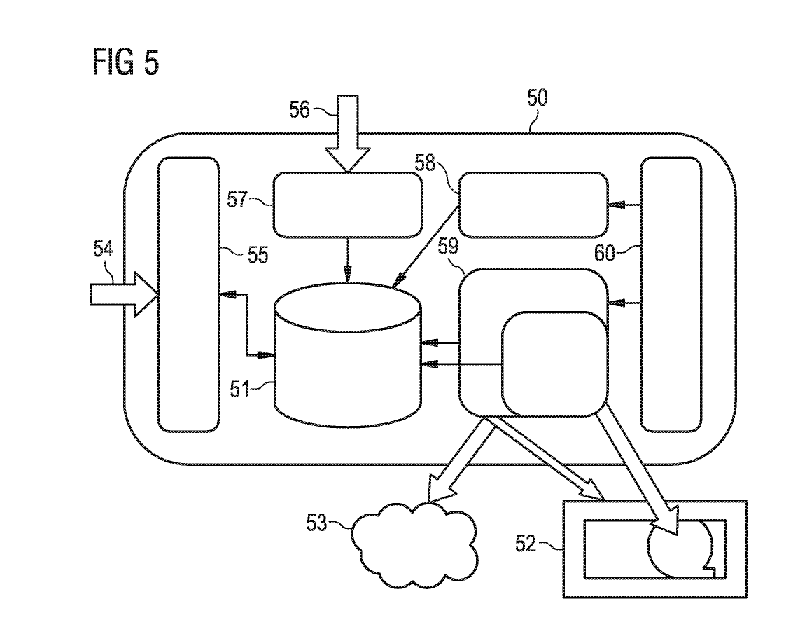

FIG. 5 shows a storage device 50 according to one example. The storage device 50 is, for example, a so-called “storage appliance” which enables the archiving of different versions of files or other data objects. At least the respectively current version of the file is retained on a powerful, in the example internal, mass storage system 51. In addition, copies of the current version and, where applicable, any existing previous versions are retained on a further storage medium. FIG. 5 shows, for example, that such copies are stored on an, in the example external, tape drive 52 or in a so-called cloud memory 53, i.e. a storage system connected via a data network, in particular the Internet.

The storage device 50 according to FIG. 5 has a first interface 54 to access data stored in the storage device 50. This involves, for example, an interface according to the NFS protocol for the UNIX operating system family or an interface according to the CIFS protocol for the Windows operating system family. The requests known from these protocols for writing and reading and, where appropriate, for deleting and renaming individual files can be transferred via the first interface 54 to the storage device 50.

In the example, the commands received via the interface 54 are analyzed and, insofar as permissible, implemented via a processing component 55 of the storage device 50. In the example, a software component that is stored on a non-volatile storage medium of the storage device 50 is used for this purpose. The processing component 55 implements the corresponding requests in a manner known per se for a file system 2 of the mass storage system 51, for example, the GPFS file system (“General Parallel File System”) from IBM, which is particularly suitable for cluster systems.

In the configuration of the entire or a part of the storage device 50 as a WORM system, requests to change and rename files and directories are acknowledged with a corresponding error message and are not executed. Deletion of a file is either not permissible at all or is permissible only at the end of a predefined retention period. Impermissible delete commands are similarly acknowledged with an error message. In permissible delete commands, in particular also delete commands for regular files in a conventional, rewritable file system, deletion of a file is recorded in an additional log file which is taken into account accordingly in the subsequent creation of file lists 10 and similar information based on the meta-information. For example, a corresponding inode 7 is marked as invalid and therefore the associated object as deleted through storage of an additional attribute or through storage of a predefined value in an existing attribute.

In addition to the implementation of the actual request, specific preceding and subsequent actions are also executed in the described design to store the additional metadata. Particularly during writing of new files or directories, associated metadata are stored in the associated inode 7 of the file system 2 of the mass storage system 51. For this purpose, the software component comprises a so-called daemon process which responds to events according to the so-called Data Management API (DMAPI) interface and, inter alia, stores the additional information required for the methods described above in extended attributes of the GPFS file system. For example, the “create” and “postcreate” events can be intercepted via the DMAPI interface for the creation of files.

Alternatively, it is also possible to determine the required additional information in a one-off and/or regularly carried out search run over all directories. For example, all directory objects 8 of the file system 2 can be checked in a first step for changes since a last search run. The inodes 7 of the directory entry 17 of the changed directory objects 8 are determined in a second step. Corresponding additional information is then stored for these inodes 7 in a third step. Optionally, a check can first be carried out before a further storage to determine whether the inodes 7 already contain current additional information.

The storage device 50 furthermore comprises a second interface 56 for administration. Via the second interface 56, a system administrator or other authorized user has access to a configuration dialog 57 with which the behavior of the storage device 50 can be configured in detail. For example, it is possible to select via the configuration dialog 57 whether the file system of the mass storage system 51 provided via the interface 57 or individual areas thereof are to behave as a WORM storage medium or as a normal, multiple (over-) writable storage medium.

The storage device 50 furthermore comprises a scan component 58 which serves, inter alia, to process the metadata additionally stored in the inodes 7. In addition, the storage device 50 comprises a so-called “object mover” 59 responsible for the on-demand backup of files on a different storage medium. A backup may result from this for different reasons. For example, it may involve a regular backup of the objects stored in the storage device 50. Alternatively, it may also involve a relocation of a file or file version in a hierarchical storage system or archive system in which, for example, files not used for a long time or outdated versions are moved from the mass storage system 51 onto the tape drive 52 and/or the cloud memory 53. Here, the object mover 59 creates a new object at the destination location, containing at least the data of the backed up object and, where appropriate, further metadata for the backup. In addition, the metadata stored in the inodes 7 of the file system of the mass storage system 51 are updated accordingly. In a backup in an extended attribute, for example, the current date is noted as the last backup date 20. Alternatively, in a relocation, the object associated with the inode 7 can be marked as deleted from the mass storage system 51 or can be replaced by a so-called “stub” which refers to the new storage location.

The storage device 50 furthermore comprises a so-called “backup manager” 60 responsible for the automatic data backup of data stored on the mass storage system 51 according to default settings of the configuration dialog 57. To perform this task as efficiently as possible, the backup manager 60 accesses, inter alia, the scan device 58 to select objects intended to be backed up by the object mover 59 from the internal mass storage system 51 onto a further, external storage medium.

A so-called “incremental forever” backup system is described below with reference to FIG. 5. The term “incremental forever backup” is intended to express that, following an initial basic backup, only the objects newly stored or modified on the mass storage system 51 since the last backup, in particular regular files and directory objects, are always backed up. Other backup strategies such as, for example, a differential backup, in which the difference since the last basic backup is always backed up, or a full backup, in which the entire content or predefined parts of the mass storage system 51 are always backed up, can obviously also be used.

Different system parameters are predefined via the configuration interface 57. For example, a so-called mountpoint of a file system 2 for which the incremental backup is intended to be carried out is defined. In addition, a time interval between different file versions to be backed up can be specified. For example, it can be specified that the storage device 50 performs a backup of the files stored in the mass storage system 51 on an hourly, daily or weekly basis. Further criteria such as, for example, the minimum or maximum size of files to be backed up can also be predefined via the configuration dialog 57.

If a predefined backup time or other event triggering a backup is reached, all files of the mass storage system 51 must first be defined which currently need to be backed up. To do this, the storage device 50 uses the scan device 51 to define all files whose creation or modification date lies temporally after the date of the last backup. It is noted that, in the example according to FIG. 4A, this information is already contained in the inodes 7 of the file system 2 as the backup date 20. It can thus be established purely on the basis of a scan of all inodes 7 which file objects 9 are essentially to be taken into consideration for a backup, without loading the individual file objects 9 of the second storage area 6. Alternatively, the date of the last backup can also be stored at a different location in the storage device 51. For example, a backup time globally valid for all objects of the mass storage system 51 can be stored or defined. In a differential backup, the date of the last full backup is to be used instead of the date of the last backup.

A corresponding file list 10 with objects to be backed up is then created on the basis of the metadata contained in the inodes 7, in particular the filename 14 contained therein and/or further information of a path specification 12 or 13, only for the objects that have been modified since the time of the last backup. Along with the path specifications 12 or 13 and/or the filename 14, the file list 10 to be created may contain further information, in particular a direct reference to the associated inode 7, the size of the file and other information of the metadata. A list 10 of this type may, for example, be transferred to the object mover 59 to store new backup objects for modified files on the tape drive 52 or the cloud memory 53.

However, along with the aforementioned backup system, the data structures according to FIGS. 3A and 4A and the algorithms according to FIGS. 3B and 4B are also suitable for a multiplicity of other applications. In particular, the mechanisms described are suitable for a multiplicity of data processing tasks in which data are processed at least partially with associated metadata.

As a further example, image management software is outlined below in which individual images are to be filtered out from a large number of existing image data on the basis of metadata such as, for example, a creation time period, a recording location or information relating to a pattern contained in the image. Data processing tasks of this type are conventionally performed by one of two possible approaches. The meta-information is either stored together with the actual data, i.e. in this case the image data. This has the disadvantage that, in a search via the metadata, all image files must be opened and at least partially read in. If, in the image data described here, associated metadata are stored as so-called EXIF data in an image format such as, for example, a JPEG image format, at least the header information of the respective image file must be read in first before a processing is possible. This results in the frequent repositioning, already described above, of read heads of the mass storage system and therefore a slower processing speed.

A different approach consists of storing the required metadata in a separate database, in particular a relational database or an object database. In this case, all tasks required to respond to a request are available in a common database for an accelerated processing. However, the second-mentioned approach has the disadvantage that modifications made by other software components to the stored data, for example, a reworking of the image by an image processing program, may not in some instances be recognized by the database. The problem therefore essentially exists of keeping the metadata stored in the database consistent with the actual data.

According to one example, such application-specific metadata are additionally stored in the inodes 7 of the file system 2. For example, a recording location of a photo can be stored in the extended attributes of a GPFS file system. In this case, the methods described above for scanning a large list of files are applicable. In particular, the further files that need to be taken into account for a processing, for example, compilation of a slideshow, can then be determined only on the basis of a list of inodes 7. Since the application-specific attributes are stored directly in the extended file system 2, a discrepancy cannot occur here also between the stored metadata on the one hand and possibly modified image data on the other hand.

The method already described above using the DMAPI interface is particularly suitable for this purpose. If corresponding mechanisms are integrated at file system level into a storage device 50 to create and maintain the extended metadata stored in the inodes 7, these mechanisms are always maintained independently from an application that is used.

1.-16. (canceled)

17. A storage device comprising:
at least one interface to access files stored by the storage device, and
at least one mass storage system for non-volatile storage of files;
wherein the storage device is configured, on receiving a write command to write a file via the at least one interface, to store metadata relating to the at least one file in an inode associated with the file of the mass storage system, and the stored metadata relating to the file comprise at least the file name of the file and information relating to a directory in which the file is stored.

18. The storage device according to claim 17, further comprising at least one software component executed by the storage device, wherein the at least one software component is configured to create a file list on the basis of the stored metadata.

19. The storage device according to claim 18, wherein the software component is configured for file management and selects files for further processing on the basis of the stored metadata.

20. The storage device according to claim 19, wherein the software component is configured to back up files on the basis of at least one time indication stored in the metadata, a modification, creation and/or backup date of the file allocated to the metadata.

21. The storage device according to claim 17, configured to store the metadata in the inodes allocated to the files of a POSIX-compatible file system of the at least one mass storage system.

22. The storage device according to claim 21, which is configured to provide at least a part of the stored metadata of a selected file comprising the filename of the file and information relating to the directory in which the file is stored, as extended attributes via the at least one interface.

23. A method of creating a file list of files of a POSIX-compatible file system comprising:
scanning a predefined group of inodes to acquire metadata of a plurality of files allocated to the inodes, wherein the metadata for each file stored in one of the inodes comprise at least the file name of respectively allocated file and information relating to a directory in which the respective file is stored;
defining file names and path specifications of files based on the metadata stored in the inodes; and
creating a file list on the basis of the defined file names and path specifications.

24. The method according to claim 23, wherein the metadata comprise at least one further attribute, or a date of a last backup of the respectively allocated file, and the at least one further attribute is transferred into the file list and/or a transfer of a file into the file list is decided on the basis of the at least one further attribute.

25. The method according to claim 24, wherein
in the step of scanning the predefined list of inodes, a check is carried out to determine whether the metadata of an inode satisfy at least one predefined condition; and
in the step of creating the file list, an entry is created for a file allocated to an inode only if the predefined condition for the metadata of the respective inode is satisfied.

26. A mass storage system comprising a POSIX-compatible file system comprising at least one directory and a plurality of files stored in the directory, wherein
an inode with metadata relating to the respective file is allocated to each file;
the directory comprises an allocation between file names of the plurality of files and the inode respectively allocated to a file; and
the metadata relating to the respective file comprise at least the file name of the allocated file and information relating to the at least one directory.

27. The mass storage system according to claim 26, wherein the information relating to the at least one directory comprises a reference to an inode allocated to the directory.

28. The mass storage system according to claim 26, wherein the file system is a WORM file system and the information relating to the at least one directory comprises a path specification of the allocated file from a predefined reference point or a mountpoint of the WORM file system.

29. The mass storage system according to claim 28, wherein the metadata relating to the respective file comprise a full path specification with a path specification to the directory in which the file is stored, and the filename itself.

30. The mass storage system according to claim 26, wherein the metadata relating to the file additionally comprise a reference to an inode allocated to a predefined reference point or a mountpoint, of the file system.

31. The mass storage system according to claim 26, wherein the filename and information relating to the at least one directory are stored in an extended attribute of the file system.
